(19) United States
(12) Patent Application Publication
(10) Pub. No.: US 2007/0003394 A1
(43) Pub. Date: Jan. 4, 2007

(54) Anti-cross threading fastener

(76) Inventors: Paul G. Carey, Plymouth, MI (US); Edward Sala, Saline, MI (US); Andrew Blaszak, Dearborn, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/344,963

(22) Filed: Feb. 1, 2006

Related U.S. Application Data
(60) Provisional application No. 60/648,862, filed on Feb. 1, 2005.

(51) Int. Cl. F16B 25/00

(52) U.S. Cl. 411/386

(57) ABSTRACT

Cross-threading occurs generally due to angular and axial misalignment between the threaded members during assembly. It is particularly troublesome for unskilled laborers and automated assembly operations, resulting in reduced productivity and damaged components. Accordingly, an anti-cross threading fastener assembly is provided. The assembly comprises a head, a shaft connected with the head, the shaft comprising: a threaded portion located proximate the head, an unthreaded portion located distal the head, and wherein upon insertion of the shaft into a bore of a body, the unthreaded portion coaxially aligns the threaded portion with threads of the bore of the body by contacting an unthreaded portion of the bore of the body.

### CROSS-REFERENCE TO RELATED APPLICATIONS

This application claims priority from U.S. Provisional Patent Application No. 60/648,862 filed on Feb. 1, 2005, which is hereby incorporated by reference.

### FIELD OF THE INVENTION

The present invention relates to anti-cross threading fasteners, and more particularly, to anti-cross threading fastener assembly.

### BACKGROUND

Threaded fastener technology is used in numerous manufacturing industries such as machines, automobiles, trains, plains, engines, and the like. Threaded fasteners may be bolts, screws, studs, rods, or other substantially round members having uniform, non-uniform, or tapered external helical threads that are screwably engaged into mating threaded fasteners such as nuts, bolts or holes having substantially matching internal helical threads. For proper engagement of the externally and internally threaded fasteners, the longitudinal axis of the externally threaded member must be substantially collinear with the longitudinal axis of the mating internally threaded member. When the externally threaded member is not substantially collinear with the internally threaded member, cross-threading can occur.

Cross-threading occurs generally due to angular and axial misalignment between the threaded members during assembly, and is particularly troublesome for unskilled laborers and automated assembly operations, resulting in reduced productivity and damaged components, which are generally not reusable. Specifically, cross-threading is the result of the threads of the two members attempting to engage at least one half pitch out of alignment. When this situation happens, the two members are not collinear with each other and wedging of the threads will occur as the threaded helixes are rotated against each other. If rotation continues, then threads on one or both members will be structurally damaged.

U.S. Pat. No. 5,836,731 issued to MAThread, Inc. discloses an anti-cross threading fastener having curved-surface lead-threads that allow the surface of the lead-threads to cam over the mating threads of the other member and thereby align collinearly the longitudinal axis of both members. When the threads engage and cross threading starts to occur, the modified lead allows the part to slip or cam back into a straight position. This can help to minimize the occurrence of cross threading during assembly. However, while this design has been useful for many fastener applications, it has not been completely successful in use with tube fittings. The use of Mathreads with tube fittings does not prevent cross-threading to the extent that automated installation is possible. As such, it is still necessary to hand start tube fittings utilizing Mathread threads during assembly.

Tube fittings connect runs of tubing for in-line, offset, multi-port, and mounting configurations to other tubing sections, pipe, hose, and other fluid transfer components. Systems are typically configured with straight sections connected by fittings or specially formed connections and joints. Current tube fitting products require hand starting into the assembly to prevent cross threading of the part. This process is very time consuming on the assembly line and requires an extra operation. Therefore, what is needed is an anti-cross threading fastener device that can be utilized with tube fittings to eliminate the possibility of cross-threading and allow the part to be assembled with a drive gun and eliminate the need for a hand start operation on the assembly line.

### SUMMARY OF THE INVENTION

An anti-cross threading assembly is disclosed herein. The assembly comprises a head, a shaft connected with the head, the shaft comprising: a threaded portion located proximate the head, an unthreaded portion located distal the head, and wherein upon insertion of the shaft into a bore of a body, the unthreaded portion coaxially aligns the threaded portion with threads of the bore of the body by contacting an unthreaded portion of the bore of the body.

In another embodiment, an anti-cross threading assembly comprises a head, a shaft connected with the head, the shaft comprising: a threaded portion located proximate the head, an unthreaded portion located distal the head, a body having a bore therein, the bore comprising: an opening, a threaded portion proximate the opening, an unthreaded portion distal the opening, a chamfered section located between the threaded portion and the unthreaded portion, wherein upon insertion of the shaft into the bore, the unthreaded portion of the shaft encounters the chamfered section coaxially aligning the threaded portion of the shaft with the threaded portion of the bore to prevent misalignment.

In yet another embodiment, a method of preventing cross-threading of a fastener comprises providing a fastener that comprises a head and a shaft connected with the head, the shaft having a threaded portion proximate the head and an unthreaded portion distal the head, providing a body having a bore, the bore having a threaded portion, an unthreaded portion, and a chamfered section located between the threaded portion and the unthreaded portion, inserting the unthreaded portion of the shaft into the bore, contacting the unthreaded portion of the shaft with the chamfered section, aligning the threaded portion of the shaft with the threaded portion of the bore, and threading the threaded portion of the shaft with the threaded portion of the bore.

### DESCRIPTION OF THE DRAWINGS

Objects and advantages together with the operation of the invention may be better understood by reference to the following detailed description taken in connection with the following illustrations, wherein:

FIG. 1 is a diagrammatical view of an anti-cross threading fastener assembly; and

FIG. 2 is a diagrammatical view of the anti-cross threading fastener assembly.

### DETAILED DESCRIPTION

The anti-cross threading fastener of the present invention utilizes a new fitting design in combination with a new port design to eliminate the possibility of cross threading. As such, previously hand started fasteners can be used to assemble parts with a drive gun. The anti-cross threading design of the present invention forces the two fastening components to line up axially prior to engagement of the threads. With little or no angularity between the components, the parts can be assembled with a drive gun.

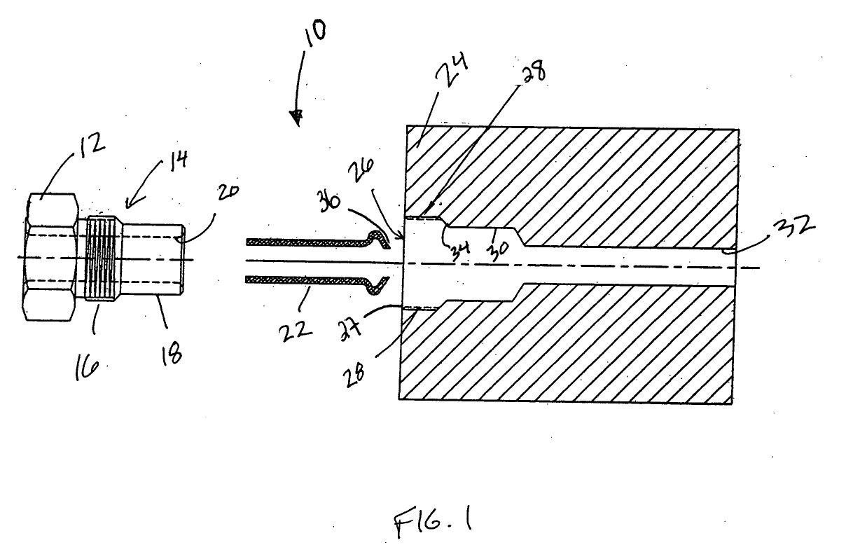

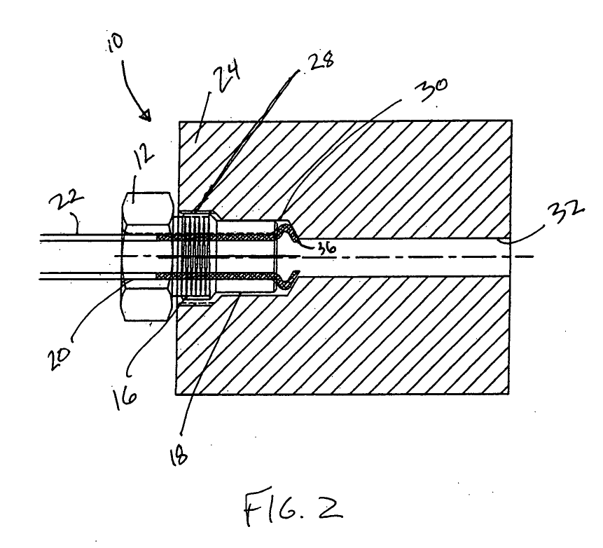

The present invention will now be described in accordance with the preferred embodiment as shown in FIGS. 1 and 2. While the preferred embodiment of the invention is described with reference to tube fittings, it should be clear to those reading this disclosure that the invention can be used with any fastener in which anti-cross threading is desired. In general terms, a fitting design and receiver port design work together to allow consistent and reliable assembly without the need to hand start the fastener.

As shown in FIG. 1, a fastener 10 comprises a head 12, a shaft 14 connected with the head 12. The shaft 14 comprises a threaded portion 16 proximate the head 12 and an unthreaded portion 18 distal the head 12. The shaft 14 also comprises a hollow bore 20 therethrough. The fastener 10 is capable of receiving a tubular portion 22 through the bore 20 so that the fastener 10 can be mounted in a fixed position relative to a body 24 so as to connect the tube 22 relative to the body 24.

The body 24 includes a bore 26 that comprises an opening 27, a threaded portion 28 of a specified diameter proximate the opening 27 and that is threadedly engagable with the threaded portion 16 of the fastener 10, an unthreaded portion 30 that is distal the opening 27, and a chamfered section 34 located between the threaded portion 28 and the unthreaded portion 30. The threaded portion 28 of the bore 26 is in fluid communication and coaxial with the unthreaded portion 30, which is of a smaller diameter and is located downstream of the threaded portion 28. Located downstream of the unthreaded portion 30 and still in fluid communication therewith is channel 32.

As shown in FIG. 2, the tube 22 is held within the bore 20 of the fastener 10 and the fastener 10 is inserted into the bore 26. The unthreaded portion 18 of the fastener 10 passes easily through the threaded portion 28 of the bore 26. As the unthreaded portion 18 of the fastener 10 encounters the chamfered section 34 between the body's 24 threaded portion 28 and unthreaded portion 30, the fastener 10 is coaxially aligned with the bore 26. Because the unthreaded port portion 30 is only slightly larger than the unthreaded fastener shaft portion 18, the fastener 10 and the bore 26 align themselves to prevent misalignment. As such, the fastener 10 is insertable within the bore 26 until engagement of the fastener threaded portion 16 and the bore threaded portion 28 permits threaded engagement.

Upon insertion of the fastener 10 with the tubular portion 22 through the bore 20 thereof, an end 36 of the tubular portion can be crimped to create a seal between the tubular portion 22 and the body 24. As the threaded portion 16 of the fastener 10 is threaded with the threaded portion 28 of the bore 26, the end 36 of the tubular portion 22 is crimped, as shown in FIG. 2. This allows fluid to flow through the channel 32 into the tubular portion 22 and then thereout. Additionally, fluid can flow the other way, i.e., from the tubular portion 22 through the channel 32.

The fastener 10 is assembled to the body 24 by inserting the unthreaded portion of the shaft 12 into the bore 26. The unthreaded portion 18 of the shaft 14 contacts the chamfered section 34 of the bore 26 first. This then causes the unthreaded portion 18 of the shaft 12 to align with the unthreaded portion 30 of the bore 26. This in turn aligns the threaded portion 16 of the shaft 14 with the threaded portion 28 of the bore 26. Finally, a user can then thread the threaded portion 16 of the shaft 14 with the threaded portion 28 of the bore 26.

As such, the special nose configuration of the fastener works in conjunction with the specially designed bore receiver to align the two parts axially prior to threaded engagement. This prevents the mating threads from having excessive angularity relative to each other, which prevents a cross threading condition. As such, the alignment of the components is achieved before the threaded engagement. This ensures that the assembly will not cross thread therefore eliminating the need for hand starting. As such, the parts can then be assembled with a drive gun.

Although the preferred embodiment of the present invention has been illustrated in the accompanying drawings and described in the foregoing detailed description, it is to be understood that the present invention is not to be limited to just the preferred embodiment disclosed, but that the invention described herein is capable of numerous rearrangements, modifications and substitutions without departing from the scope of the claims hereafter.

Having thus described the invention, we claim:

1. An anti-cross threading assembly comprising:
a head;
a shaft connected with said head, said shaft comprising:
a threaded portion located proximate said head;
an unthreaded portion located distal said head; and
wherein upon insertion of said shaft into a bore of a body, said unthreaded portion coaxially aligns said threaded portion with threads of said bore of said body by contacting an unthreaded portion of said bore of said body.

2. The anti-cross threading assembly of claim 1, further comprising:
a body having a bore therein, said bore comprising:
an opening;
a threaded portion proximate said opening;
an unthreaded portion distal said opening; and
a chamfered section located between said threaded portion and said unthreaded portion.

3. The anti-cross threading assembly of claim 2, wherein upon insertion of said shaft into said bore, said unthreaded portion of said shaft contacts said chamfered section coaxially aligning said threaded portion of said shaft with said threaded portion of said bore to prevent misalignment.

4. The anti-cross threading assembly of claim 3, wherein said shaft includes a hollow bore therethrough.

5. The anti-cross threading assembly of claim 4, wherein said hollow bore is capable of receiving a tubular portion.

6. The anti-cross threading assembly of claim 5, further comprising a tube inserted through said hollow bore.

7. The anti-cross threading assembly of claim 6, wherein threading said threaded portion of said shaft with said threaded portion of said bore causes an end of said tubular portion to crimp.

8. An anti-cross threading assembly comprising:
a head;
a shaft connected with said head, said shaft comprising:
a threaded portion located proximate said head;
an unthreaded portion located distal said head;
a body having a bore therein, said bore comprising:
an opening;
a threaded portion proximate said opening;
an unthreaded portion distal said opening;
a chamfered section located between said threaded portion and said unthreaded portion;
wherein upon insertion of said shaft into said bore, said unthreaded portion of said shaft encounters said chamfered section coaxially aligning said threaded portion of said shaft with said threaded portion of said bore to prevent misalignment.

9. The anti-cross threading assembly of claim 8, wherein said shaft includes a hollow bore therethrough.

10. The anti-cross threading assembly of claim 9, wherein said hollow bore is capable of receiving a tubular portion.

11. The anti-cross threading assembly of claim 10, further comprising a tube inserted through said hollow bore.

12. The anti-cross threading assembly of claim 11, wherein threading said threaded portion of said shaft with said threaded portion of said bore causes an end of said tubular portion to crimp.

13. A method of preventing cross-threading of a fastener comprising:
providing a fastener that comprises a head and a shaft connected with said head, said shaft having a threaded portion proximate said head and an unthreaded portion distal said head;
providing a body having a bore, said bore having a threaded portion, an unthreaded portion, and a chamfered section located between said threaded portion and said unthreaded portion;
inserting said unthreaded portion of said shaft into said bore;
contacting said unthreaded portion of said shaft with said chamfered section;
aligning said threaded portion of said shaft with said threaded portion of said bore; and
threading said threaded portion of said shaft with said threaded portion of said bore.

14. The method of claim 13, wherein said shaft includes a hollow bore therethrough.

15. The method of claim 14, further comprising inserting a tubular portion through said hollow bore.

16. The method of claim 15, further comprising crimping an end of said tubular portion by further threading said threaded portion of said shaft with said threaded portion of said bore.
